(19) United States
(12) Patent Application Publication
(10) Pub. No.: US 2025/0018829 A1
(43) Pub. Date: Jan. 16, 2025

(54) METHOD FOR ELECTRICALLY DRIVABLE VEHICLE, IN PARTICULAR A UTILITY VEHICLE, METHOD FOR A VEHICLE-EXTERNAL SERVER, COMPUTER PROGRAM, COMPUTER-READABLE MEDIUM, CONTROLLER, ELECTRICALLY DRIVABLE VEHICLE, VEHICLE-EXTERNAL SERVER

(71) Applicant: ZF CV Systems Global GmbH, Bern (CH)

(72) Inventors: Johannes Heseding, Hannover (DE); Philip Meyer-Rössler, Giesen (DE); Daniel Pyttlik, Hohnhorst (DE); Daniel Rasch, Sarstedt (DE); Janik Ricke, Uetze (DE); Mark Schaper, Hannover (DE)

(21) Appl. No.: 18/898,342

(22) Filed: Sep. 26, 2024

Related U.S. Application Data
(63) Continuation of application No. PCT/EP2023/055685, filed on Mar. 7, 2023.

(30) Foreign Application Priority Data
Apr. 8, 2022 (DE) 10 2022 108 592.9

(51) Int. Cl. B60L 58/13; B60L 7/18; B60L 53/66

(52) U.S. Cl. CPC B60L 58/13; B60L 7/18; B60L 53/66; B60L 2200/28; B60L 2240/12; B60L 2240/62; B60L 2240/642; B60L 2240/66; B60L 2240/68; B60L 2240/70; B60L 2250/10

(57) ABSTRACT

Method for an electrically drivable vehicle, in particular a utility vehicle, with an energy storage device and an electric drive capable of regenerative braking, wherein the energy storage device can be charged during regenerative braking and the energy storage device can be charged at a vehicle-external charging station, the method including the steps: determining a state of charge, wherein the state of charge includes information about whether the energy storage device is being charged by the vehicle-external charging station; detecting, depending on the state of charge, vehicle information concerning the vehicle, in particular the utility vehicle, and position information concerning the position of the vehicle, in particular the utility vehicle; transmitting the vehicle information and the position information to an external server; and receiving a target state of charge from the vehicle-external server.

### CROSS-REFERENCE TO RELATED APPLICATIONS

This application is a continuation application of international patent application PCT/EP2023/055685, filed Mar. 7, 2023, designating the United States and claiming priority from German application 10 2022 108 592.9, filed Apr. 8, 2022, and the entire content of both applications is incorporated herein by reference.

### TECHNICAL FIELD

The disclosure relates to a method for an electrically drivable vehicle, in particular a utility vehicle. The disclosure also relates to a method for a vehicle-external server, a computer program and/or a computer-readable medium, a controller, an electrically drivable vehicle, in particular a utility vehicle, and a vehicle-external server.

The disclosure relates in particular to battery electric vehicles (BEVs), in particular utility vehicles that have passed a Type II-A test in accordance with ‘Regulation No. 13 of the United Nations Economic Commission for Europe (UNECE)—Uniform Rules for Type-Approval of Vehicles of Categories M, N, and O with Respect to Brakes [2016/194]’ (ECE R 13). This requires maintaining a speed of 30 km/h over a 6 km long downhill section with a 7% incline without the use of friction brakes. In addition, high-performance retarders are intended for conventional vehicles to minimize brake wear and enable longer downhill sections at higher speeds.

### BACKGROUND

The Type II-A test can be fulfilled by BEVs if the battery state of charge allows the energy recovered by recuperation to be absorbed. Otherwise, the fulfilment of the Type II-A test cannot be guaranteed. This means that an energy storage device must be chargeable by regenerative braking of an electric drive without the risk of overloading the energy storage device and thus damaging it. Therefore, separate measures must be implemented for BEVs: Option 1 includes the addition of another wear-free continuous brake (brake resistor, retarder or similar), Option 2 includes the implementation of a brake performance estimator with two warning thresholds that warns a driver if a friction brake can no longer guarantee specified decelerations. Option 3 provides for the implementation of intelligent energy management functions that work predictively and keep the battery state of charge within a suitable range if necessary. For this purpose, it may be necessary for the energy storage device to be charged at a vehicle-external charging station only up to a determinable target state of charge.

It is conceivable to maintain a buffer, that is, to set a difference between the maximum capacity of the energy storage device and the target state of charge. However, the need for a buffer provision is only necessary in very few cases. It therefore does not make sense to waste such a buffer as a predetermined offset of possible battery usage. This is particularly relevant because this would significantly increase the cost of the same range of the vehicle and, according to the state of knowledge, the driving scenario of a battery that is too full typically occurs rather rarely in reality.

DE 10 2020 001 782 A1 discloses a method for charging a traction battery of a battery-electric motor vehicle (BEV). Before charging the traction battery at a charging device, a position of the motor vehicle can be determined. Taking into account the environmental topology, traffic data and traffic density, which for example can be made available by a navigation system and a communication interface, it is possible to predict where, when, over what periods of time and what amount of energy, for example when braking in traffic or on a downhill gradient, can be recuperated to charge the traction battery. A controller is configured to control the charging of the traction battery to a target state of charge when charging at a stationary charging device, for example a charging station. The controller can access various pieces of information for this purpose, for example from the location determining device, the navigation system and/or the communication interface. It is possible that if there is no relevant downhill section on the planned route and no recuperation energy will be available during braking, the target state of charge for example is set to maximum. If, on the other hand, there are longer downhill sections, the target state of charge can be set to a lower value so that the recuperation of the braking energy can be used to the maximum. If, for example, the route of the motor vehicle is not known, a reduced target state of charge can be determined for safety reasons.

The fundamental problem for a predictive solution such as the one in the above method according to the prior art is that the expected energy balance in the vehicle, that is, the energy consumption from driving taking into account energy recovery through recuperation, cannot be reliably predicted. For example, entering a route into a navigation system and predicting energy consumption when driving along the route is also not expedient on its own, as the driver can stop following the route at any time. Likewise, the vehicle mass, which is decisive for the potential energy of the vehicle, can change at any time during the journey, that is, along a route, if the vehicle is loaded and/or unloaded.

The problem lies primarily in the availability of data and in the computing power in the vehicle due to the complexity of the variants in the calculation in advance.

There are also known solutions in which the energy consumption of the vehicle is temporarily increased in a driving situation when an excessively high state of charge is detected, for example by switching on consumers or by increasing losses, for example by operating a compressor, a cooling system, or an electric motor at an inefficient operating point. This artificially empties the energy storage device to enable regenerative braking. However, artificially emptying the energy storage device is inefficient and economically and ecologically disadvantageous.

According to the current state of knowledge, Option 1 of a brake performance estimator, which is permissible according to ECE R 13, is complex to implement since a specific prediction of the possible deceleration of the friction brakes to a target value or target value threshold is subject to many unknown variables and is therefore difficult to realize.

### SUMMARY

It is an object of the disclosure to enable an improved determination of a target state of charge, while at the same time avoiding the need to artificially empty the energy storage device.

The object is, for example, achieved by a method for an electrically drivable vehicle, in particular a utility vehicle, with an energy storage device and an electric drive capable of regenerative braking, wherein the energy storage device can be charged during service braking and the energy storage device can be charged at a vehicle-external charging station. The method includes: determining a state of charge, wherein the state of charge includes the information about whether the energy storage device is being charged by the vehicle-external charging station; detecting, depending on the state of charge, vehicle information relating to the vehicle, in particular the utility vehicle, and position information relating to the position of the vehicle, in particular the utility vehicle; transmitting the vehicle information and the position information to a vehicle-external server; and receiving a target state of charge from the vehicle-external server.

The electrically drivable vehicle, in particular the utility vehicle, is hereinafter referred to as the vehicle. The energy storage device and the electric drive are set up in such a way that the energy storage device provides an electric current for the electric drive to drive the vehicle. The electric drive is configured to decelerate the vehicle via regenerative braking, wherein kinetic energy of the vehicle is converted into electrical energy when the vehicle decelerates. The electric drive and the energy storage device are set up to store the energy converted by the regenerative braking in the energy storage device.

The energy storage device can be charged by the vehicle-external charging station. The vehicle-external charging station and the vehicle each have a corresponding interface to connect the vehicle or the energy storage device thereof to the vehicle-external charging station for charging the energy storage device. For this purpose, the vehicle-external charging station can be, for example, a stationary or mobile charging station, an energy storage unit of a trailer carried along with and/or able to be carried along with the vehicle, an energy storage exchange device or another device for charging the energy storage device. The vehicle-external charging station and the vehicle are set up to charge the energy storage device to a target state of charge. The target state of charge can be indicated, for example, by a proportion of the maximum capacity or a maximum state of charge of the energy storage device. The difference between the maximum state of charge and the target state of charge is called the buffer.

First, the charging status is determined. The charging status indicates whether the energy storage device is being charged by the vehicle-external charging station. Thus, the method begins with a recognition of whether the vehicle or its energy storage device is being charged by the vehicle-external charging station. Charging of the vehicle or energy storage device occurs until a state of charge (SoC) of the energy storage device has reached the target state of charge and/or the charging of the vehicle is interrupted. To determine the charging status, the vehicle may have an energy storage control device that is set up to manage charging and discharging during the operation of the vehicle.

In order to determine the target state of charge, the vehicle information and the position information are detected and are transmitted to the external server in each case. The detection of the vehicle information and the position information is carried out depending on the charging status. In particular, the detection of the vehicle information and position information may take place when the vehicle or the energy storage device of the vehicle is being charged, and the detection of vehicle information and position information may be omitted if the vehicle is not being charged. Alternatively or additionally, the detection and transmission of the vehicle information and the position information or parts thereof can also be carried out before charging in order to enable processing by the external server before charging. This can reduce the time at the charging station, as the data are not detected and transmitted only at the start of charging, and thus the target state of charge can be transmitted earlier.

The vehicle information includes one or more items of information relating to the vehicle as such, and the position information includes information that describes the position or location at which the vehicle is located. The vehicle information and the position information are suitable variables for determining the target state of charge, which are transmitted to the external server to determine the target state of charge. The vehicle-external server uses the vehicle information and position information to determine the target state of charge and transmits the target state of charge to the vehicle. Alternatively or additionally, the target state of charge can be transmitted to the vehicle-external charging station. The vehicle receives the target state of charge from the vehicle-external server. Based on the target state of charge received by the vehicle, the energy storage device of the vehicle is charged until the state of charge of the energy storage device reaches the target state of charge. This means that the energy storage device is charged depending on the received target state of charge.

The disclosure has recognized that the proposed method can also ensure the use of complicated calculations of the target state of charge by the vehicle-external server in order to prevent the energy storage device from having to be artificially emptied and/or the recuperation ability from being restricted. By transmitting the vehicle information and the position information to the external server, various parameters and/or information can optionally be transmitted, which, starting from a minimal approach, can be used to reduce a dynamic buffer, that is, a buffer that occurs during a journey of the vehicle along a route, via an arbitrarily refinable calculation of the target state of charge. This ensures particularly effective operation of the vehicle and the achievement of the longest possible range. This enables a cost-effective and feasible solution for battery-electric vehicles that must meet the Type II-A test, because no additional retarders need to be provided and a brake performance estimator is unnecessary.

In various embodiments, the detection of the vehicle information and the position information is carried out when the energy storage device is being charged by the vehicle-external charging station. This enables exact and up-to-date detection of the variables suitable for determining the target state of charge. Optionally, the vehicle information and/or the position information can also be captured when the energy storage device is not being charged by the vehicle-external charging station in order to enable tracking and thus improve the determination of the target state of charge by the vehicle-external server through a predictive process. The vehicle information and the position information can also be captured immediately before charging.

In various embodiments, the vehicle information includes a vehicle identifier. In this embodiment, it is possible for the vehicle information to be summarized in a vehicle identifier or to be represented by a vehicle identifier. This enables effective transmission from the vehicle to the external server, since not all components of the vehicle information have to be transmitted separately, but the transmission of the vehicle identifier is sufficient to retrieve vehicle characteristics linked to the vehicle identifier.

In various embodiments, the electrically drivable vehicle, in particular a utility vehicle, includes a towing vehicle and a trailer, wherein the transmission of the ¬vehicle ¬information and the position information to the external server is carried out from the towing vehicle and from the trailer to the external server. In other words, separate data collection is carried out in each segment of the vehicle. Alternatively or additionally, the transmission of the vehicle information and the position information to the external server includes transmission from the trailer to the towing vehicle and from the towing vehicle to the external server of the vehicle. In other words, data needed to determine and refine the target state of charge (target SoC) can be collected from locally connected systems within a vehicle segment. If it is possible to exchange data locally between vehicle segments, one segment collects the data. The data are then transmitted to the external server for the calculation of the target state of charge.

In various embodiments, the method also includes: transmission of route information to the external server. Alternatively or additionally, the method involves the transmission of loading information associated with a route. The route information and/or loading information optionally includes information from a dispatcher, which includes, for example, destinations of a trip and/or information about loading and/or unloading the vehicle. The loading information makes it possible to adjust the target state of charge via weight information. The loading information can include information regarding the difference between a target and an actual state. The route information and/or loading information enables improved determination of the target state of charge by the vehicle-external server.

In various embodiments, the method also includes: receiving a route proposal and/or a loading proposal from the vehicle-external server. By receiving route proposals and/or loading proposals, it is possible, for example, to avoid having to limit the target state of charge at all when a route corresponding to the route proposal is driven and/or the vehicle is loaded and/or unloaded in accordance with the loading proposal. It also makes it possible to adapt to current conditions, such as the traffic situation, taking into account the optimal profile of a reserve of the state of charge.

In various embodiments, the route proposal and/or the loading proposal should be matched to the target state of charge in order to enable the vehicle to be charged and operated as efficiently as possible.

In various embodiments, the method also includes: receiving an incompatible route proposal and/or an incompatible loading proposal from the vehicle-external server, wherein compliance with the incompatible route proposal and/or the incompatible loading proposal by the vehicle, in particular a utility vehicle, implies a restriction of the ability of the electric drive to perform regenerative braking; determining the ability of the electric drive to perform regenerative braking; initiating a warning and/or a change in energy consumption depending on the ability of the electric drive to perform regenerative braking. The ability of the electric drive to perform regenerative braking may be limited if the energy storage device is fully charged, that is, has a state of charge equal to the maximum capacity of the energy storage device. In this case, the electric drive cannot perform regenerative braking without first having to empty the energy storage device, in particular artificially. This limits the ability of the electric drive to perform regenerative braking. This embodiment has recognized that the vehicle-external server can determine incompatible route proposals and/or loading proposals and transmit them to the vehicle. This allows a driver of the vehicle to be warned if the vehicle follows the incompatible route proposal and/or loading proposal. In addition or alternatively, a change, in particular an increase, can be made to energy consumption if the ability of the electric drive to perform regenerative braking is limited. The energy storage device is emptied as a result and the ability of the electric drive to perform regenerative braking is restored. This can reduce the efficiency of driving, but can avert damage.

In various embodiments, the method also includes: Initiating a warning about energy consumption depending on the ability of the electric drive to perform regenerative braking, wherein the warning contains an adapted route proposal taking into account the position of the vehicle, in particular a utility vehicle, wherein the route proposal is adapted in such a way that a minimal change in energy consumption is required depending on the ability of the vehicle to perform regenerative braking. This allows a driver of the vehicle to be informed about a route to be traversed with increased energy efficiency. As part of the warning message, the driver is sent a new route proposal that takes into account the current vehicle position and allows for the lowest possible destruction of charging energy, wherein communication with the server can be received for the purpose of calculating the updated route proposal.

In various embodiments, the method also includes: transmitting a charging request to the vehicle-external charging station to enable the charging of the energy storage device by the vehicle-external charging station according to the received target state of charge. Optionally, the charging request includes information that includes the target state of charge.

In various embodiments, the transmission and reception are carried out via an in-vehicle mobile communications interface. This makes it possible to transmit and receive information or data particularly effectively. Optionally, transmission and reception can be carried out via a communication interface that is different from the mobile communications interface, in particular wireless, for example via a WLAN. A towing vehicle and/or trailer optionally has a communication interface implemented as a mobile communications interface.

In various embodiments, the method also includes: Receiving a plurality of target states of charge from the vehicle-external server, wherein each of the target states of charge corresponds to one of a plurality of vehicle-external charging stations in an environment of the vehicle, in particular a utility vehicle. The plurality of the target states of charge can be stored in order to enable charging according to the respective target state of charge, for example, in the event that network availability is not available on a route section with one or more of the vehicle-external charging stations. The storage of the determined and received target states of charge in the vehicle can be carried out, for example, for the next charging stations within a radius of the vehicle or along a probable route as a fallback level in the event of unavailability from a mobile radio network.

According to an aspect of the disclosure, a method is provided for a vehicle-external server. The method includes: receiving vehicle information and position information from an electrically drivable vehicle, in particular a utility vehicle, wherein the vehicle information relates to the electrically drivable vehicle, in particular the utility vehicle, and wherein the position information relates to a position of the vehicle, in particular the utility vehicle; determining a target state of charge based on the vehicle information and position information; and transmitting the target state of charge to the electrically drivable vehicle, in particular the utility vehicle.

The vehicle-external server can be described as a central processing unit (cloud). The vehicle-external server is set up to determine the target state of charge. The disclosure has recognized that the determination of a reliable and accurate target state of charge has to be carried out by an external server due to the necessary complex calculations. This makes it possible to use various calculation methods to determine the target state of charge. It is also possible to take into account various parameters and/or information that are suitable for determining the target state of charge. The method according to the disclosure thus shifts the calculation of the target state of charge from the vehicle to the vehicle-external server. For example, the vehicle-external server can even use a brute force method to ensure that the target state of charge is set in such a way that regardless of the route the vehicle can take and a possible loading of the vehicle and/or a change in the load while driving, the recuperation capability is not restricted.

In order to determine the target state of charge, the external server receives the vehicle information and position information from the vehicle. Based on the vehicle information and the position information, the external server calculates the target state of charge. The vehicle information and the position information are used to determine the energy consumption and/or energy recovery through recuperation when driving the vehicle after charging the energy storage device at the vehicle-external charging station. Hence the state of charge of the energy storage device is modelled and the target state of charge can be adjusted according to the modeling in such a way that artificial emptying and/or limited recuperation capacity of the energy storage device is avoided.

The target state of charge determined by the external server is transmitted to the electrically drivable vehicle in order to charge at a vehicle-external charging station according to the target state of charge.

In various embodiments, the vehicle information includes a vehicle identifier, wherein the determination of the target state of charge is carried out taking into account the following vehicle data that can be determined by the server on the basis of the vehicle identifier: vehicle type, vehicle mass, performance of an electric drive, model of a drive train, maximum charging capacity, charging power characteristic, efficiency chain, driving resistance coefficients, and vehicle geometry data. By receiving the vehicle information, which includes a vehicle identifier, the server can use the vehicle identifier to determine a set of vehicle data suitable for determining the target state of charge. The vehicle data that can be determined in this way can, for example, be stored on the server and thus be retrieved by the vehicle-external server on the basis of the vehicle identifier. Optionally, the vehicle data that can be determined can be stored on a fleet management system that is different from the vehicle-external server and is or can be connected to the vehicle-external server, and can be retrieved from the fleet management system by the vehicle-external server on the basis of the vehicle identifier. This makes it possible to effectively receive and determine vehicle data suitable for calculating the target state of charge based on the vehicle identifier. For example, the vehicle data that can be determined include vehicle type, vehicle mass, performance of an electric drive, model of a drive train, maximum charging capacity, charging power characteristic, efficiency chain, driving resistance coefficients, and vehicle geometry data. The vehicle type implies, for example, information regarding a power, a charging capacity of the energy storage device, a recuperation power, and a permissible total mass. The vehicle type may also imply information regarding the vehicle data mentioned below. The vehicle mass includes, for example, information regarding the permissible total weight and/or a towing capacity. The performance of the electric drive includes, for example, information about the power with which the vehicle can be driven and with regard to the recuperation power. For example, the charging power characteristic includes information about battery charging power and/or battery capacity. The efficiency chain includes, for example, information regarding the energy conversion options of the vehicle, including possible optional energy conversion options resulting from the addition of consumers and/or changes in operating parameters. The driving resistance coefficients include, for example, information from which a wheel resistance performance, an incline resistance performance, an acceleration resistance performance and/or an air resistance performance can be determined. The driving resistance coefficients can be adjusted, for example, by operating parameters. For example, an air resistance coefficient can be changed by actively changing the arrangement of air resistance elements such as air resistance flaps. The vehicle geometry data include information that determines air resistance. This enables an advantageous refinement of the calculation of the target state of charge on the basis of the vehicle identifier and on the basis of the vehicle data that can be determined through the vehicle identifier.

In various embodiments, the target state of charge is determined on the basis of a kinematic model of the vehicle, especially the utility vehicle. The kinematic model is a model for numerical simulation for routes that can be driven by the vehicle. The vehicle is modeled based on the received vehicle information. The drivable routes are determined on the basis of the position information. In other words, in the simulation, the modeled vehicle follows potential routes taking into account physical conditions, optionally statistically captured and/or predictable meteorological conditions as well as traffic conditions such as speed limit and/or a target speed profile. State of charge curves are determined. Optionally, acceleration and/or deceleration is taken into account for the simulation in order to achieve predetermined speeds, in particular depending on the time and/or a respective itinerary or route based on map data. The kinematic model determines the target state of charge and thus enables a reliable determination of the target state of charge in order to charge the vehicle accordingly at the vehicle-external charging station. Alternatively or additionally, the use of machine learning is possible, wherein, for example, the target state of charge is determined from a historical record and/or modeling.

In various embodiments, the determination of the target state of charge is carried out taking into account routes and/or driving profiles that can be determined by the server on the basis of the position information, on the basis of weather data, on the basis of traffic information, and on the basis of further charging stations located in an environment of the vehicle, in particular the utility vehicle. Based on the position information, the vehicle-external server can determine the aforementioned characteristics. The characteristics that can be determined in this way can be used by the vehicle-external server to improve the determination of the target state of charge taking into account one or more of the characteristics. Based on the position information, the external server can, for example, use map data to determine routes and/or driving profiles that can be driven by the vehicle in order to be able to consider a large number of possible routes or sections. For each of the routes, a state of charge curve is determined and it is determined whether the state of charge curve meets a predetermined condition. For example, whether the state of charge corresponding to the state of charge curve reaches no more than the maximum capacity of the energy storage device. Traffic information includes, for example, data about the current traffic situation, such as traffic jams. Weather data include, for example, information regarding temperature and/or wind prevailing in an environment of the vehicle, and are captured as a static mean or are currently forecast at the time of calculation for the time of passing. Based on the position information, charging stations in the environment of the vehicle can be determined. In particular, it is possible that the characteristics that can be determined on the basis of the position information are linked to the vehicle data that can be determined on the basis of the vehicle identifier. In particular, it is possible for an air resistance coefficient that can be determined on the basis of the vehicle identifier to be linked to weather data, wherein the weather data include data relating to the wind in order to take into account the effect of headwind, tailwind and/or crosswind on driving efficiency. For example, a temperature prevailing in an environment of the vehicle based on the position information can be linked to information about the energy storage device that can be determined from the vehicle identifier in order to take into account temperature-dependent effects that affect the capacity and/or performance of the energy storage device. Thus, an advantageous refinement of the calculation of the target state of charge is possible on the basis of the position information and on the basis of the characteristics that can be determined by the position information.

In various embodiments, determining the target state of charge is determined by taking into account a specific scenario, wherein the scenario includes driving along a route with a downhill gradient and at a speed. This ensures compliance with the Type II-A test if the route, downhill gradient and speed are adjusted accordingly. The scenario can also be a suitable termination criterion for the advance calculation of the target state of charge and thus define an upper bound of the target state of charge. Based on the scenario, a state of charge curve is determined, from which the target state of charge can be determined.

In various embodiments, the method also includes: determining a route proposal and/or a loading proposal, and transmitting the route proposal and/or a loading proposal to the electrically drivable vehicle, in particular the utility vehicle.

In various embodiments, the route proposal and/or the loading proposal are determined in such a way that the determined target state of charge leads to a state of charge corresponding to a maximum load capacity of an energy storage device of the vehicle, in particular the utility vehicle. This embodiment has recognized that the target state of charge can be below the maximum charging capacity of the energy storage device of the vehicle if, for example, it is foreseeable that the vehicle will gain further energy through recuperation due to a downhill journey and the energy storage device will be charged by recharging via regenerative braking in such a way that the maximum charging capacity is reached while driving. Thus, the target state of charge leads to the maximum charging capacity being reached. A state of charge curve corresponding to the state of charge along the route according to the route proposal together with the loading proposal does not exceed the maximum charging capacity.

In various embodiments, the determination of the target state of charge is supported by artificial intelligence and/or taking into account a risk weighting factor. Determining the target state of charge using artificial intelligence, for example, enables the effective inclusion of previously determined target states of charge, that is, the inclusion of historical data. The consideration of a risk weighting factor allows for effective consideration of different scenarios and/or different routes that may be traversed by the vehicle. For example, routes that should not or cannot be driven, for example due to the vehicle mass and/or vehicle height, can be ignored and/or weighted weakly. If a dynamic buffer is required, no range is wasted, as a state of charge of 100% is reached during the journey. This can save energy and costs, as less energy has to be drawn from the vehicle-external charging station.

In various embodiments, the method also includes: determining and/or receiving fleet information from a fleet management system, wherein the determination of the target state of charge is carried out taking into account the fleet information. The fleet information is transferred from the fleet management system to the vehicle-external server. The fleet information can include, for example, proposals of routes from a dispatcher, taking into account predefined destinations and/or sub-destinations. The fleet management system can be a system operated in particular by the dispatcher for coordinating and managing a fleet of vehicles.

According to an aspect of the disclosure, a computer program and/or a computer-readable medium is provided. The computer program and/or the computer-readable medium contains instructions which, when executed by a computer, cause the computer to carry out the method according to the disclosure and/or steps thereof. Optionally, the computer program and/or the computer-readable medium includes instructions which, when executed by a computer, cause the computer to carry out the method steps described as advantageous or optional in order to achieve a related technical effect.

According to an aspect of the disclosure, a controller for an electrically drivable vehicle, in particular a utility vehicle, is provided with an energy storage device and an electric drive capable of regenerative braking, wherein the energy storage device can be charged during regenerative braking and the energy storage device can be charged at a vehicle-external charging station. The controller is set up to carry out the method for an electrically drivable vehicle, in particular a utility vehicle, according to the disclosure. Optionally, the controller is set up to carry out the method steps described as advantageous or optional in order to achieve a related technical effect.

In various embodiments, the controller has a vehicle interface, a data processing device and a communication interface for communication with a vehicle-external server. The vehicle interface enables communication with the vehicle in order to retrieve or determine vehicle information. The communication interface is set up to communicate with the vehicle-external server. Thus, the communication interface enables sending to and receiving from the vehicle-external server. Preferably, the communication interface has a mobile communications interface.

According to an aspect of the disclosure, an electrically drivable vehicle, in particular a utility vehicle, is provided with an energy storage device and an electric drive capable of regenerative braking and with a controller according to the disclosure. The energy storage device can be charged during regenerative braking and the energy storage device can be charged at a vehicle-external charging station. Optionally, the controller of the vehicle and/or the vehicle is set up to carry out the method steps described as advantageous or optional in order to achieve a related technical effect.

According to an aspect of the disclosure, a vehicle-external server is provided. The vehicle-external server is set up to carry out the method for a vehicle-external server according to the disclosure. Optionally, the vehicle-external server is set up to carry out the method steps described as advantageous or optional in order to achieve a related technical effect.

### BRIEF DESCRIPTION OF DRAWINGS

The invention will now be described with reference to the drawings wherein:

FIG. 1 shows a schematic representation of a process sequence of a method according to an embodiment of the disclosure;

FIG. 2 shows a schematic representation of an overview of a vehicle, in particular a utility vehicle, according to an embodiment of the disclosure, a vehicle-external charging station and a vehicle-external server according to an embodiment of the disclosure;

FIG. 3 shows a schematic representation of a vehicle, in particular a utility vehicle, according to a further embodiment of the disclosure;

FIG. 4 shows a schematic representation of a vehicle-external server according to an embodiment of the disclosure; and,

FIGS. 5A to 5E show a schematic charging curve and four state of charge curves of an energy storage device of a vehicle, in particular a utility vehicle.

### DETAILED DESCRIPTION

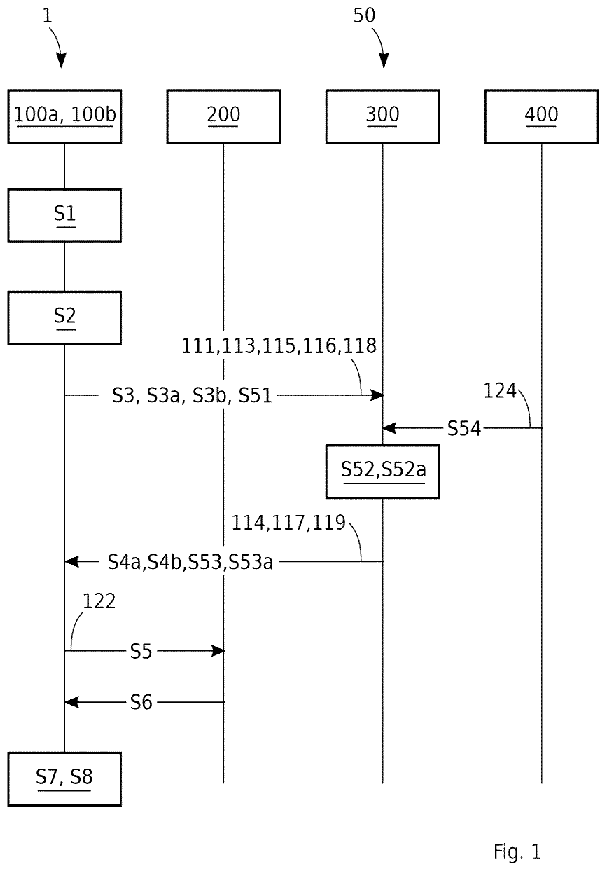

FIG. 1 shows a schematic representation of process sequence of a method 1, 50 according to an embodiment of the disclosure. In particular, FIG. 1 shows a method 1 for an electrically drivable vehicle 100a, in particular a utility vehicle 100b, with an energy storage device 20 and an electric drive 21 capable of regenerative braking, wherein the energy storage device 20 can be charged during regenerative braking NB and the energy storage device 20 can be charged at a vehicle-external charging station 200. FIG. 1 also shows a method 50 for a vehicle-external server 300.

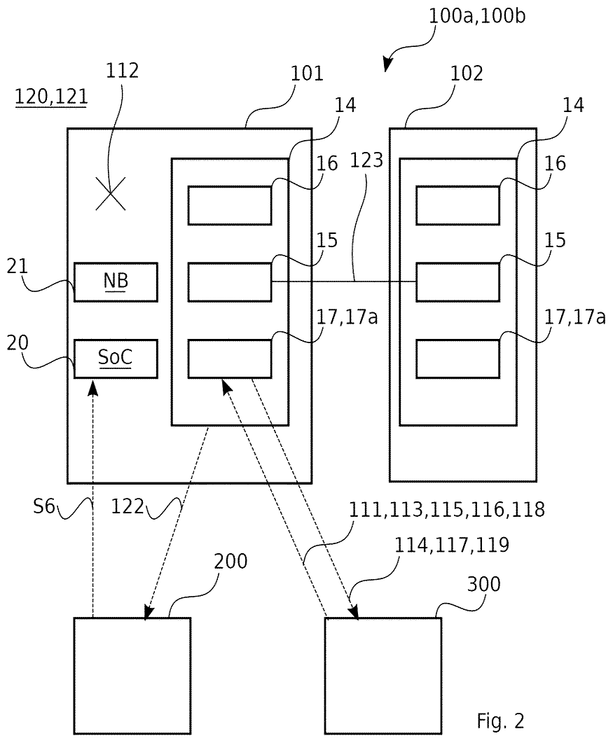

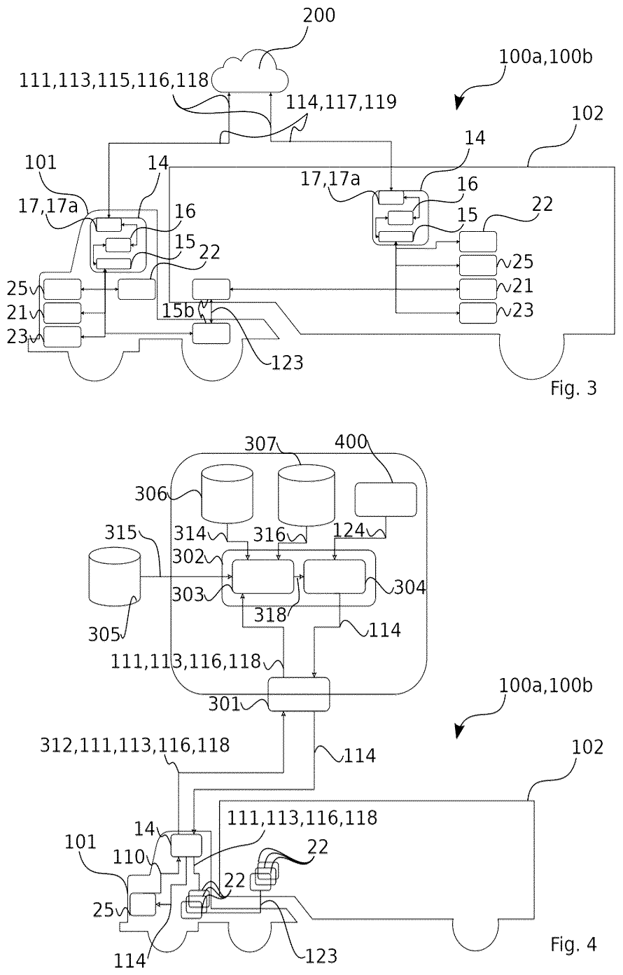

The vehicle 100a, in particular the utility vehicle 100b, is hereinafter referred to as the vehicle 100a, 100b. The vehicle 100a, 100b is described in more detail with reference to FIGS. 2 and 3.

In FIG. 1, the method 1 for the vehicle 100a, 100b begins with a determination S1 of a charging status 110, wherein the charging status 110 includes the information about whether the energy storage device 20 is being charged by the vehicle-external charging station 200. The charging status 110 can thus indicate that the energy storage device 20 is being charged by the vehicle-external charging station 200, or that the energy storage device 20 is not being charged by the vehicle-external charging station 200. Thus the state can be captured that the vehicle 100a, 100b is being charged.

This is followed by detecting S2, depending on the charging status 110, vehicle information 111 concerning the vehicle 100a, 100b, and position information 113 concerning the position 112 of the vehicle 100a, 100b. Detecting vehicle information 111 and position information 113 S2 takes place when the energy storage device 20 is being charged by the vehicle-external charging station 200. The vehicle information 111 includes a vehicle identifier 115.

The vehicle information 111 and the position information 113 are then transmitted S3 to an external server 300. The transmission S3 of the vehicle information 111 and the position information 113 to the vehicle-external server 300 is carried out either by the towing vehicle 101 or by the trailer 102 to the vehicle-external server 300 (see FIG. 3). Alternatively, transmitting S3 vehicle information 111 and position information 113 to the vehicle-external server 300 includes transmitting S3a from the trailer 102 to the towing vehicle 101 and from the towing vehicle 101 to the vehicle-external server 300 (see FIGS. 2 and 4).

When transmitting S3 the vehicle information 111 and the position information 113, route information 116 and loading information 118 relating to a route 121 are also transmitted S3b to the vehicle-external server 300. The route information 116 can be detected, for example, using a navigation system and/or user input. The loading information 118 can be detected by a mass determination system, for example. The loading information 118 indicates a constant or changing mass of the vehicle 100a, 100b and can be derived, for example, from a current mass of the vehicle 100a, 100b determined in the vehicle 100a, 100b from a brake system 23 and/or with axle loads (onboard-weighing-see COMMISSION IMPLEMENTING REGULATION (EU) 2019/1213). This can take into account the coupling, uncoupling and/or recoupling of trailers 102 and/or vehicle loading and/or unloading by a dispatcher.

The transmission S3, S3b is carried out via an on-board mobile communications interface 17a. In other words, at the start of the charging, the vehicle identifier 115 and/or vehicle parameters and GPS position are transmitted to the cloud or the vehicle-external server 300 via a GSM/LTE/5G module, such as Telematik, as well as data necessary for billing the service. Optionally, further data are transmitted that refine the determination S52 of a target state of charge 114 adapted to the current position.

The vehicle-external server 300 determines the target state of charge 114 as described below, with reference to the method 50 for the vehicle-external server 300 and with reference to FIG. 4.

According to FIG. 1, the target state of charge 114 is received S4 from the vehicle-external server 300 and a route proposal 117 and a loading proposal 119 are received S4a from the vehicle-external server 300. The route proposal 117 and the loading proposal 119 are each matched to the target state of charge 114. In addition, an incompatible route proposal 117 and an incompatible loading proposal 119 are received S4b from the vehicle-external server 300, wherein compliance with the incompatible route proposal 117 and/or the incompatible loading proposal 119 by the vehicle 100a, 100b implies a restriction of the ability of the electric drive 21 to perform regenerative braking NB. Receiving S4c a plurality of target states of charge 114 from the vehicle-external server 300 also occurs, wherein each of the target states of charge 114 corresponds to one of a plurality of vehicle-external charging stations 200 in an environment 120 of the vehicle 100a, 100b. Optionally, optimal local and/or temporal charging points or recommended charging stations, which are calculated on the basis of the available route data, are transmitted to the vehicle 100a, 100b. The reception S4, S4a, S4b, S4c is carried out via the on-board mobile communications interface 17a.

In accordance with the method 1 described above for the vehicle 100a, 100b, the corresponding steps of the method 50 for the vehicle-external server 300 are carried out by the vehicle-external server 300.

The method 50 for the vehicle-external server 300 begins with reception S51 of the vehicle information 111 and the position information 113. The vehicle information 111 includes the vehicle identifier 115. In addition, the vehicle-external server receives the route information 116 and the loading information 118 associated with the route 121.

This is followed by the reception S54 of fleet information 124 from a fleet management system 400 (see also FIG. 4). The vehicle-external server 300 performs determination S52 of the target state of charge 114 based on the vehicle information 111 and the position information 113 (see FIG. 4). In addition, the target state of charge 114 is determined by taking into account vehicle data 314 that can be determined by the server 300 on the basis of the vehicle identifier 115 and on the basis of the vehicle identifier 115 and the position information 113 (see FIG. 4).

As shown in FIG. 1, a determination S52a of a route proposal 117 and a loading proposal 119 takes place. The determination S52a of the route proposal 117 and the loading proposal 119 is carried out in such a way that the determined target state of charge 114 leads to a state of charge SoC of the energy storage device 20 of the vehicle 100a, 100b corresponding to a maximum charging capacity.

This is followed by a transmission of S53 of the target state of charge 114 to the electrically drivable vehicle 100a, 100b and a transmission S53a of the route proposal 117 and the loading proposal 119 to the electrically drivable vehicle 100a, 100b.

After the vehicle 100a, 100b has received the target state of charge 114, a charging request 122 is transmitted S5 from the vehicle 100a, 100b to the vehicle-external charging station 200. This is followed by charging S6 of the energy storage device 20 of the vehicle 100a, 100b in accordance with the charging request 122 by the vehicle-external charging station 200.

After the charging S6, for example during a journey of the vehicle 100a, 100b, determination S7 is carried out of the ability of the electric drive 21 to perform regenerative braking NB. Depending on the ability of the electric drive 21 to perform regenerative braking NB, a warning and/or a change in energy consumption is/are triggered S8.

FIG. 2 shows a schematic representation of an overview of a vehicle 100a, in particular a utility vehicle 100b, according to an embodiment of the disclosure, a vehicle-external charging station 200 and a vehicle-external server 300 according to an embodiment of the disclosure.

The vehicle 100a, 100b is set up to carry out the method 1 described with reference to FIG. 1 for the vehicle 100a, 100b. The vehicle 100a, 100b is located at a position 112 of the vehicle 100a, 100b in an environment 120 of the vehicle 100a, 100b and can travel on a route 121. The vehicle-external server 300 is set up to carry out the method 50 described with reference to FIG. 1 for the vehicle-external server 300.

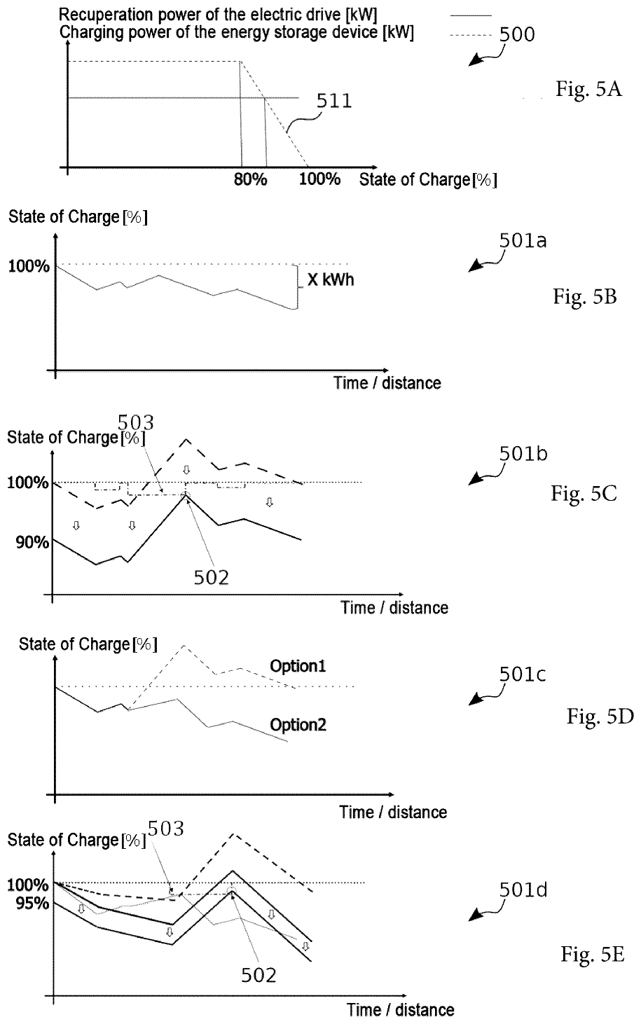

The vehicle 100a, 100b include a towing vehicle 101 and a trailer 102. The vehicle 100a, 100b or the towing vehicle 101 of the vehicle 100a, 100b contains an energy storage device 20 and an electric drive 21 capable of regenerative braking NB. The energy storage device 20 can be charged during regenerative braking NB and the energy storage device 20 can be charged at the vehicle-external charging station 200. The energy storage device 20 is an accumulator or rechargeable battery. The energy storage device 20 has a state of charge SoC, which indicates the amount of energy that can be converted into electrical energy by the energy storage device 20. The state of charge SoC is limited by the energy storage device 20, in particular by the maximum capacity of the energy storage device 20. The vehicle-external charging station 200 is set up to charge S6 the energy storage device of the vehicle 100a, 100b according to a charging request 122. The energy storage device 20 and the properties of the energy storage device 20 are also described with reference to FIGS. 5A to 5E.

In FIG. 2, the towing vehicle 101 and the trailer 102 each contain a controller 14 with a vehicle interface 15, a data processing device 16 and a communication interface 17. The vehicle interface 15 is set up to determine or capture vehicle information 111 relating to the vehicle 100a, 100b, that is, corresponding to the towing vehicle 101 or the trailer 102. The vehicle interface 15 is set up to capture position information 113 regarding the vehicle 100a, 100b. For example, the vehicle interface 15 connects the controller to a position sensor, such as a GPS sensor, to detect the position 112.

With the vehicle interfaces 15, a vehicle-internal communication link 123 can be established between the towing vehicle 101 and the trailer 102. More precisely, the communication link 123 is established between the vehicle interface 15 of the towing vehicle 101 and the vehicle manufacturer 15 of the trailer 102. This means that vehicle information 111 relating to the trailer 102 can be transferred from the trailer 102 to the towing vehicle 101. The communication interfaces 17 are mobile communication interfaces 17a, for example interfaces for communication in a GSM (3G), LTE (4G) and/or 5G network. The communication interfaces 17 are each set up to communicate with the vehicle-external server 300. This allows the vehicle 100a, 100b to transmit information or data to the vehicle-external server 300 and receive it from the vehicle-external server 300.

A system is thus created including the vehicle 100a, 100b and the connected or connectable cloud, that is, the vehicle-external server 300, which can effectively determine and use the target state of charge 114.

FIG. 3 shows a schematic representation of a vehicle 100a, in particular a utility vehicle 100b, according to a further embodiment of the disclosure. The vehicle 100a, 100b according to FIG. 3 is described with reference to FIG. 2, wherein the differences from the vehicle 100a, 100b according to FIG. 2 are described. The vehicle 100a, 100b according to FIG. 3 is illustrated in an alternative representation.

The vehicle 100a, 100b includes a towing vehicle 101 and a trailer 102. The towing vehicle 101 and the trailer 102 each contain a controller 14, a central controller 22, an electric drive 21, an electromechanical braking system 23, an energy storage control device 25 and an interface connection 15b.

The vehicle interface 15 of the towing vehicle 101 is connected to the central controller 22, the electric drive 21, the electromechanical braking system 23, the interface connection 15b and the energy storage control device 25, each of which is contained by the towing vehicle 101. Accordingly, the vehicle interface 15 of the trailer 102 is connected to the central controller 22, the electric drive 21, the electromechanical braking system 23, the interface connection 15b and the energy storage control device 25, each of which is contained by the trailer 102.

This allows the respective controller 14 to detect comprehensive vehicle information 111 of the towing vehicle 101 or trailer 102. The central controller 22 is set up in particular to store the vehicle identifier 115 and transmit it to the controller 14. The vehicle interface 15 connected to the electric drive 21 allows the retrieval and/or detection of information relating to the electric drive 21, in particular status information and/or the performance of the electric drive 21. The vehicle interface 15 connected to the electromechanical braking system 23 enables the retrieval and/or detection of information relating to the electromechanical braking system 23, in particular status information and/or the performance of the electromechanical braking system 23. The vehicle interface 15 connected to the energy storage control device 25 enables the charging status 110 and/or the maximum charging capacity and/or the charging power characteristic of the battery storage device 20 to be retrieved and/or detected. For example, the energy storage control device 25 is formed by a vehicle controller (VCU) and/or an electric drive controller 21 (eDrive controller).

The respective communication interface 17 of the controllers 14 is connected to the vehicle-external server 300. This means that there is no need to transmit vehicle information 111 from the trailer 102 to the towing vehicle 101. Optionally, vehicle information 111 can be transmitted and received between the trailer 101 and the towing vehicle 102 through the interface connections 15b. An external communication link 123 can be established between the interface connections 15b of the vehicle 101 and the trailer 102.

FIG. 4 shows a schematic representation of a vehicle-external server 300 according to an embodiment of the disclosure. The vehicle-external server 300 is set up to carry out the method 50 described with reference to FIG. 1 for the vehicle-external server 300. FIG. 4 further schematically shows a simple representation of a vehicle 100a, 100b according to an embodiment of the disclosure, wherein reference is made to the description of the vehicles 100a, 100b according to FIGS. 2 and 3 for the description of the vehicle 100a, 100b according to FIG. 4.

The vehicle 100a, 100b includes a towing vehicle 101 and a trailer 102. The towing vehicle 101 and the trailer 102 each contain a plurality of central controllers 22. Each of the central controllers 22 is set up to detect and/or retrieve the vehicle information 111, the position information 113, the route information 116 and/or the loading information 118. The towing vehicle 101 and the trailer 102 are connected via an internal communication link 123 so that the vehicle information 111, the position information 113, the route information 116 and the loading information 118 can be transmitted from the trailer 102 to the towing vehicle 101.

The towing vehicle 101 has an energy storage control device 25. The energy storage control device 25 is connected to the controller 14 of the towing vehicle 101 to transmit the charging status 110 to the controller to 14. Depending on the charging status 110, that is, if the charging status 110 indicates that the energy storage device 20 is being charged by the vehicle-external charging station 200, a state of charge request 312 is transmitted from the vehicle 100a, 100b to the vehicle-external server 300. For this purpose, the vehicle-external server 300 has a communication module 301. The vehicle 100a, 100b can be connected to the vehicle-external server 300 via the on-board controller 14 and via the server-side communication module 301, for example via a mobile communication network. In addition to the state of charge request 312, the vehicle 100a, 100b transmits the vehicle information 111, the position information 113, the route information 116 and the loading information 118.

The vehicle-external server 300 contains a determination module 302 with a kinematic model 303 and a state of charge module 304, a vehicle database 306 and a map database 307. The vehicle-external server 300 can be connected to a weather module 305 to retrieve weather data 315.

The vehicle information 111, position information 113, route information 116 and loading information 118 received from the vehicle-external server 300 are transmitted to the determination module 302 or the kinematic model 303 for determining S52 the target state of charge 114. The vehicle information 111 includes the vehicle identifier 115.

By transmitting the route information 116, in particular the destination and optionally one or more intermediate destinations are transmitted to the vehicle-external server 300. This makes it possible to calculate an optimal route 126 based on the vehicle configuration and the current state of charge SoC, as well as to transmit route proposals 117 and/or optimal charging points to the vehicle 100a, 100b. A charging point is a vehicle-external charging station 200 located in the environment 120 of the vehicle 100a, 100b.

Loading information 118 takes into account the actual vehicle mass for the determination of a state of charge curve 501a, 501b, 501c, 501d on the basis of a corresponding vehicle model or the kinematic model 303, wherein the target state of charge 114 is determined on the basis of the possible state of charge curves 501a, 501b, 501c, 501d. Precise consideration of the loading information 118 reduces a dynamic buffer that may be necessary.

Weather data 315 are transmitted to the kinematic model 303 by the weather module 305. In particular, the weather module 305 can provide the kinematic model 305 with information about wind and/or temperatures in the environment 120.

Topographic data 316 are transmitted from the map database 307 to the kinematic model 303. Possible routes 126 can be taken into account on the basis of the position information 113 (GPS position) and the routes or driving profiles that can be realized from the position 112, wherein the vehicle simulation model, permissible speeds, altitude profile, performance of the electric drive 21 and the energy storage device 20 can be taken into account.

On the basis of the vehicle identifier 115, which is included in the vehicle information 111, vehicle data 314 from the vehicle database 306 can be made available to the kinematic model 303. In other words, the kinematic model 303 can retrieve the vehicle data 314 from the vehicle database 306. The vehicle data 314 include, for example, a vehicle type, a vehicle mass, the performance of an electric drive 21, a model of a drive train, a maximum charging capacity, a charging power characteristic, an efficiency chain, driving resistance coefficients and/or vehicle geometry data. In particular, the vehicle information 111 and/or the vehicle data 314 may include a charging curve 500 (see FIG. 5A). This means that decreasing charging power at high charging states SoC can be taken into account in the vehicle model. The vehicle identifier 115 can be used to determine the type of vehicle 100a, 100b, the maximum vehicle mass (permissible total weight), parameters for determining the performance of the electric drive 21 (max./rated eDrive recuperation power, max./rated battery charging power, battery capacity) and a (rudimentary) model of the drive train (energy conversion, efficiency chain). The vehicle data 314 influence the level of detail of the vehicle-specific kinematic model 303, that is, the simulation information 318, for example through a specific efficiency chain for the drive and/or regenerative braking NB (eMachine, converter, transmission, battery, et cetera) to support the accuracy of the prediction of the state of charge SoC. The driving resistance coefficients include information for calculating the wheel resistance power P_{WR}=F_{WR}·vₓ≈f_{R}·m·g·vₓ·cos α, slope resistance power P_{WS}=F_{WS}·cₓ=m·g·vₓ·sin α, acceleration resistance power P_{WB}=F_{WB}·vₓ=m·aₓ·(1+∈)·vₓ, and air resistance power P_{WL}=F_{WL}·vₓ=p/2·cₓ·A·v_{r\hat{ }}2·vₓ, wherein P is a power, F is a force, vₓ is a velocity, m is a mass, g is the location factor, α is an angle, aₓ is an acceleration, ∈ is a positive constant, ρ is a density, A is a reference plane, vᵣ is a relative velocity, and cₓ is a resistance coefficient. The vehicle information 111 may include the average energy consumption per km of the vehicle in the past and/or performance data of electrical consumers or other continuous braking devices (brake resistance, retarder, et cetera) and/or the power consumption capacity of a friction brake.

From the information transmitted to the kinematic model 303, a model of the vehicle 100a, 100b is created to simulate the vehicle 100a, 100b and is transmitted to the state of charge module 304 as simulation information 318.

In the embodiment shown, the vehicle-external server 300 contains a fleet management system 400. The fleet management system 400 is set up to transmit fleet information 124 to the state of charge module 304 in order to refine the determination of the target state of charge 114. The fleet management system 400 is set up to transmit route proposals 117 to the dispatcher, taking into account predefined (sub-) destinations, the optimal state of charge profile and current traffic data. Route proposals 117 can be selected by the dispatcher, which are later transmitted to the vehicle 100a, 100b. The selected route proposals 117 include a refinement of the route proposals 117 by entering the planned (loading) weight changes at individual sub-destinations as well as a consideration of the possible charging time of the energy storage device 20 at a respective sub-destination with a vehicle-external charging station 200 by an input by dispatchers or by estimation by the vehicle-external server 300, for example by querying whether a charging point is available and a usual loading time per weight and/or number of pallets. A specification of a planned route 126 by the dispatcher in the context of determining S52 the target state of charge 114 can be taken into account. Routes 126 that should not or cannot be driven, for example due to the vehicle mass or vehicle height, are ignored or weakly weighted. It is possible to adapt the planned route 126 to the current/changed traffic situation in order to be able to take into account an optimal SoC profile. Route proposals that require an SoC limitation can be avoided. If a dynamic buffer is required, a route 126 can be chosen with which a state of charge SoC of 100% is reached during the course of the journey in order not to waste range and to save costs because less energy has to be drawn from the charging point.

The state of charge module 304 calculates the target state of charge 114 based on the kinematic model 303 and the fleet information 124. The determination module 302 is thus set up to carry out the determination S52 of the target state of charge 114, which has already been mentioned with reference to FIG. 1. For this purpose, the state of charge module 304 determines one or more state of charge curves 501a, 501b, 501c, 501d as shown in FIGS. 5A to 5E, and determines the target state of charge 114 from the possible state of charge curves 501a, 501b, 501c, 501d in such a way that effective operation of the vehicle 100a, 100b is possible. Thus, the determination S52 of the target state of charge 114 is carried out on the basis of the kinematic model 303 of the vehicle 100a, 100b, taking into account a specific scenario, wherein the scenario includes driving along a route with a downhill gradient and at a speed, taking into account the fleet information 124 and taking into account routes and/or driving profile curves that can be determined by the server 300 on the basis of the position information 113, on the basis of weather data, on the basis of traffic information, and on the basis of further charging stations 200a, 200b located in the environment 120 of the vehicle 100a, 100b. By taking into account the current traffic situation (traffic jams, detours), for example, the expected speed in the area of the traffic jam or a probable alternative route that differs from the dispatcher's route 126 can be taken into account.

The determination S52 of the target state of charge 114 is supported by artificial intelligence, and is carried out taking into account a risk weighting factor. A risk weighting factor is used to calculate the state of charge SoC to be maintained. The risk weighting factor determines, for example, the extent to which a worst-case route is to be included, or how much the possibly forced energy dissipation is included in a calculation. Optionally, the dispatcher can specify this factor.

The target state of charge 114 is transmitted from the state of charge module 304 to the communication module 301 in order to transmit the target state of charge 114 from the vehicle-external server 300 to the vehicle 100a, 100b via the communication module 301 and the communication interface 17. The controller 14 receives the target state of charge 114 via the communication interface 17 and transmits the target state of charge 114 to the energy storage control device 25 via the vehicle interface 15.

FIGS. 5A to 5E show a schematic charging curve 500 and four state of charge curves 501a, 501b, 501c, 501d of an energy storage device 20 of a vehicle 100a, in particular a utility vehicle 100b. The vehicle 100a, 100b is a vehicle 100a, 100b as described with reference to FIG. 2 or 3.

FIG. 5A shows the recuperation power of the electric drive 21 in kW as a function of the state of charge SoC of the energy storage device 20. The recuperation power of the electric drive 21 is represented by a solid line and is independent of the state of charge SoC of the energy storage device 20. FIG. 5A also shows the charging curve 500, that is, the charging power of the energy storage device 20 in kW as a function of the state of charge SoC. Typically, the charging power of the energy storage device 20 decreases in a saturation region 511. In the saturation region 511, the recuperation power is limited to such an extent that the energy storage device 20 can absorb less power than is provided by recuperation from the electric drive 21.

Each of the state of charge curves 501a, 501b, 501c, 501d shows the state of charge SoC of the energy storage device 20 as a function of the time or distance that the vehicle 100a, 100c travels. When driving, the energy stored in the energy storage device 20 is converted into kinetic energy of the vehicle 100a, 100c by the electric drive 21. This reduces the state of charge SoC depending on the time or distance. Kinetic energy can be converted by recuperation or by regenerative braking NB by the electric drive 21 and can be fed to the energy storage device 20. This can increase the state of charge SoC of the energy storage device 20. The maximum capacity of the energy storage device 20 is indicated by a horizontal dotted line.

FIG. 5B shows a first state of charge curve 501a. In the example shown in FIG. 5B, the energy storage device 20 can be charged to the maximum, that is, the target state of charge 114 corresponds to the maximum capacity of the energy storage device 20 and no dynamic buffer is necessary. The profile of the charging power corresponds to a so-called worst-case route, since from the position 112 of the vehicle 100a, 100b along any route 121, sufficient energy cannot be recovered by regenerative braking NB such that the state of charge SoC of the energy storage device 20 exceeds the maximum capacity.

FIG. 5C shows a second state of charge curve 501b. The vehicle-external server 300 recognizes that a target state of charge 114 of 100% would cause the state of charge SoC to exceed the maximum capacity of the energy storage device 20. This scenario is shown with a dotted line and would result in the energy storage device 20 being damaged, the energy storage device 20 having to be artificially emptied or the continuous braking capability of the vehicle not being guaranteed with recuperation support. To avoid this, the vehicle-external server 300 transmits a target state of charge 114 of 90% in this example of the capacity of the energy storage device 20 to the vehicle 100a, 100b. This provides for a dynamic buffer of 10%. If the vehicle 100a, 100b starts a journey with the target state of charge 114 set in this way, the state of charge SoC does not exceed the maximum capacity of the energy storage device 20 even with regenerative braking NB and thus enables effective operation of the vehicle 100a 100b. The maximum state of charge SoC is reached at a critical point 502 in the route 126 under consideration or in the scenario under consideration. The critical point 502 is a local maximum of the state of charge SoC as a function of time and/or distance. The upper dashed curve is shifted by the buffer compared to the lower curve with a solid line as indicated by the double arrows to ensure energy and performance requirements. The time and/or route sections in which recuperation takes place are marked with dotted lines. The state of charge SoC increases and there is a region 503 of maximum charging power, in which the most energy can be recovered and the state of charge SoC increases the fastest. There is no or less recuperation between areas with recuperation and the state of charge SoC decreases.

FIG. 5D shows a third state of charge curve 501c. The third state of charge curve 501c includes two options: Option1, Option2. The first option, Option1, is shown with a dashed line and would cause the state of charge SoC to exceed the maximum capacity of the energy storage device 20. The second option, Option2, is shown with a solid line and allows efficient operation of the vehicle 100a, 100b. The vehicle-external server 300 can be in contact with a dispatcher via a fleet management system 400 and can transmit the two options Option1 and Option2 to the dispatcher via the fleet management system 400. The dispatcher can select the second option Option2 via the fleet management system 400, wherein the vehicle-external server 300 then transmits a corresponding target state of charge 114 and a corresponding route proposal 117 and/or loading proposal 119 to the vehicle 100a, 100b.

FIG. 5E shows a fourth state of charge curve 501d. FIG. 5E shows four scenarios of the state of charge curve 501d. The scenario represented by the dashed curve shows a worst-case route, that is, the route 126 for which the maximum state of charge SoC is achieved with a recuperation power. The vehicle-external server 300 recognizes that the probability of the worst-case route scenario is medium and that the state of charge SoC would exceed the maximum capacity of the energy storage device 20. There is a region 503 of maximum charging power, in which the most energy can be recovered and the state of charge SoC rises the fastest. In the example shown, the state of charge SoC exceeds the maximum capacity of the energy storage device 20. The scenario represented by the upper bold curve shows the worst-case route including a possible forced energy dissipation due to an artificial emptying of the energy storage device 20. The vehicle-external server 300 recognizes that the probability of the scenario is medium and that the state of charge SoC exceeds the maximum capacity of the energy storage device 20 at a critical point K. The critical point K is a local maximum of the state of charge SoC. Therefore, the vehicle-external server 300 determines a target state of charge 114 below the maximum capacity of the energy storage device 20 and in this example determines a target state of charge 114 of 95% and thus a buffer of 5% as shown in the lower bold curve. The upper bold curve is shifted by the buffer relative to the lower bold curve as indicated by the double arrows to ensure energy and power requirements. This enables effective operation of the vehicle 100a, 100b, as the maximum capacity of the energy storage device 20 is not exceeded. The scenario represented by the thin curve shows the most likely route 121 or a best-case scenario, analogous to the first state of charge curve 501a. The probability of a route 121 determines how much energy may be forcibly dissipated. For example, if the worst-case route were to be a very probable route 126, the lowest possible/no dissipation would be taken into account and the target state of charge 114 would be set lower.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Method for electrically drivable vehicle, especially utility vehicle
14 Controller
15 Vehicle interface
15b Interface connection
16 Data processing device
17 Communication interface
17a Mobile communication interface
20 Energy storage device
21 Electric drive
22 Central controller
23 Electromechanical braking system
25 Energy storage control device
50 Method for a vehicle-external server
100a Electrically drivable vehicle
100b Electrically drivable utility vehicle
101 Towing machine
102 Trailer
110 State of charge
111 Vehicle information
112 Position
113 Position information
114 Target state of charge
115 Vehicle identifier
116 Route information
117 Route proposal
118 Loading information
119 Loading proposal
120 Environment
121 Route
122 Charging request
123 In-vehicle communication link
124 Fleet information
200 Vehicle-external charging station
300 Vehicle-external server
301 Communication module
302 Determination module
303 Kinematic model
304 State of charge module
305 Weather module
306 Vehicle database
307 Map database
311 Information
312 State of charge request
313 Data provision
314 Vehicle data
315 Weather data
316 Topographic data
318 Simulation Information
400 fleet management system
500 Charge curve
501a State of charge curve
501b State of charge curve
501c State of charge curve
501d State of charge curve
502 Critical point
503 Region
511 Saturation region
S1 Determining a state of charge
S2 Detection of vehicle information and position information
S3 Transmission of the vehicle information and position information
S3a Transmitting from trailer to towing vehicle and towing vehicle to server
S3b Transmission of route information and/or loading information
S4 Receiving a target state of charge
S4a Receiving a route proposal and/or loading proposal
S4b Receiving an incompatible route proposal and/or incompatible loading proposal
S4c Receiving a plurality of target states of charge
S5 Transmitting a charging request
S6 Charging the energy storage device
S7 Determining
S51 Receiving vehicle information and position information
S52 Determining a target state of charge
S52a Determining a route proposal and/or loading proposal
S53 Transmitting the target state of charge
S53a Submitting the route proposal and/or loading proposal
S54 Determining fleet information
NB Regenerative braking
SoC State of charge

1. A method for an electrically drivable vehicle having an energy storage device and an electric drive capable of regenerative braking, wherein the energy storage device is configured to be charged during regenerative braking and the energy storage device is further configured to be charged at a vehicle-external charging station, the method comprising:
determining a state of charge, wherein the state of charge includes information about whether the energy storage device is being charged by the vehicle-external charging station;
detecting, depending on the state of charge, vehicle information concerning the electrically drivable vehicle and position information concerning a position of the electrically drivable vehicle;
transmitting the vehicle information and the position information to a vehicle-external server; and,
receiving a target state of charge from the vehicle-external server.

2. The method of claim 1, wherein the detection of the vehicle information and the position information takes place when the energy storage device is being charged by the vehicle-external charging station.

3. The method of claim 1, wherein the vehicle information includes a vehicle identifier.

4. The method of claim 1, wherein the electrically drivable vehicle includes a towing vehicle and a trailer, wherein at least one of:
said transmitting of the vehicle information and the position information to the vehicle-external server is carried out by the towing vehicle and by the trailer to the vehicle-external server; and,
said transmitting of the vehicle information and the position information to the vehicle-external server includes a transmission from the trailer to the towing vehicle and from the towing vehicle to the vehicle-external server.

5. The method of claim 1 further comprising transmitting at least one of route information and loading information relating to a route to the vehicle-external server.

6. The method of claim 1 further comprising receiving at least one of a route proposal and a loading proposal from the vehicle-external server.

7. The method of claim 6, wherein the at least one of the route proposal and the loading proposal is matched to the target state of charge.

8. The method of claim 7 further comprising:
receiving at least one of an incompatible route proposal and an incompatible loading proposal from the vehicle-external server, wherein compliance with the at least one of the incompatible route proposal and the incompatible loading proposal by the vehicle implies a restriction of an ability of the electric drive to perform regenerative braking;
determining the ability of the electric drive to perform regenerative braking; and,
initiating at least one of a warning and a change of energy consumption depending on the ability of the electric drive to perform regenerative braking.

9. The method of claim 8 further comprising:
initiating a warning of an energy consumption depending on the ability of the electric drive to perform regenerative braking; and,
wherein the warning includes an adapted route proposal taking into account the position of the vehicle, wherein the route proposal is adapted such that a minimal change in energy consumption is required depending on the ability of the electric drive to perform regenerative braking.

10. The method of claim 1 further comprising transmitting a charging request to the vehicle-external charging station.

11. The method of claim 1, wherein said transmitting the vehicle information and the position information and said receiving the target state of charge are carried out via an on-board mobile communications interface.

12. The method of claim 1 further comprising receiving a plurality of target states of charge from the vehicle-external server, wherein each of the plurality of target states of charge corresponds to one of a plurality of vehicle-external charging stations in an environment of the vehicle.

13. The method of claim 1, wherein the vehicle is a utility vehicle.

14. A method for a vehicle-external server, the method comprising:
receiving vehicle information and position information from an electrically drivable vehicle, wherein the vehicle information relates to the electrically drivable vehicle, and wherein the position information relates to a position of the vehicle;
determining a target state of charge based on the vehicle information and the position information; and,
transmitting the target state of charge to the electrically drivable vehicle.

15. The method of claim 14, wherein:
the vehicle information includes a vehicle identifier; and,
said determining the target state of charge is carried out taking into account vehicle data that can be determined by the vehicle-external server on a basis of the vehicle identifier, the vehicle data including: a vehicle type, a vehicle mass, performance of an electric drive, a model of a drive train, a maximum charge capacity, a charging power characteristic, an efficiency chain, driving resistance coefficients, and a vehicle geometry data.

16. The method of claim 14, wherein said determining the target state of charge is carried out on a basis of a kinematic model of the vehicle.

17. The method of claim 14, wherein said determining the target state of charge is carried out taking into account at least one of routes and driving profiles that can be determined by the vehicle-external server on a basis of the position information, on a basis of weather data, on a basis of traffic information, on a basis of further charging stations located in an environment of the vehicle.

18. The method of claim 14, wherein said determining the target state of charge is carried out taking into account a determined scenario, wherein the scenario includes driving along a route with a downhill gradient and at a speed.

19. The method of claim 14 further comprising:
determining at least one of a route proposal and a loading proposal; and,
transmitting the at least one of the route proposal and the loading proposal to the electrically drivable vehicle.

20. The method of claim 19, wherein said determining the at least one of the route proposal and the loading proposal is carried out such that the determined target state of charge leads to a state of charge corresponding to a maximum charge capacity of an energy storage device of the vehicle.

21. The method of claim 14, wherein said determining the target state of charge is supported by artificial intelligence and/or takes into account a risk weighting factor.

22. The method of claim 14 further comprising:
at least one of determining and receiving fleet information from a fleet management system; and,
wherein said determining the target state of charge is carried out taking into account the fleet information.

23. The method of claim 14, wherein the vehicle is a utility vehicle.

24. A computer program stored on a non-transitory computer-readable medium, the computer program comprising commands configured, when executed by a computer, to cause the program or commands to carry out the method of claim 1.

25. A computer program stored on a non-transitory computer-readable medium, the computer program comprising commands configured, when executed by a computer, to cause the program or commands to carry out the method of claim 14.

26. A controller for an electrically drivable vehicle having an energy storage device and an electric drive capable of regenerative braking, wherein the energy storage device is configured to be charged during regenerative braking and the energy storage device is configured to be charged at a vehicle-external charging station, the controller comprising:
a non-transitory computer readable medium;
a processor;
program code stored on said non-transitory computer readable medium;
said program code being configured, when executed by said processor, to:
determine a state of charge, wherein the state of charge includes information about whether the energy storage device is being charged by the vehicle-external charging station;
detect, depending on the state of charge, vehicle information concerning the electrically drivable vehicle and position information concerning a position of the electrically drivable vehicle;
transmit the vehicle information and the position information to a vehicle-external server; and,
receive a target state of charge from the vehicle-external server.

27. The controller of claim 26 further comprising:
a vehicle interface; and,
a communication interface for communication with a vehicle-external server.

28. The controller of claim 27, wherein said communication interface has a mobile communications interface.

29. The controller of claim 26, wherein the electrically drivable vehicle is a utility vehicle.

30. An electrically drivable vehicle comprising:
an energy storage device configured to be charged during regenerative braking and at a vehicle-external charging station;
an electric drive capable of the regenerative braking;
a controller including a non-transitory computer readable medium, a processor, and program code stored on said non-transitory computer readable medium;
said program code being configured, when executed by said processor, to:
determine a state of charge, wherein the state of charge includes information about whether said energy storage device is being charged by the vehicle-external charging station;
detect, depending on the state of charge, vehicle information concerning the electrically drivable vehicle and position information concerning a position of the electrically drivable vehicle;
transmit the vehicle information and the position information to a vehicle-external server; and,
receive a target state of charge from the vehicle-external server.

31. The electrically drivable vehicle of claim 30, wherein the electrically drivable vehicle is a utility vehicle.

32. A vehicle-external server configured to carry out the method of claim 14.
